(19) United States
(12) Patent Application Publication
(10) Pub. No.: US 2004/0238998 A1
(43) Pub. Date: Dec. 2, 2004

(54) Method for treating a laminated glass sheet and use thereof

(76) Inventor: Frederic Bordeaux, Compiegne (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/485,742

(22) PCT Filed: Aug. 5, 2002
(86) PCT No.: PCT/FR02/02798

(30) Foreign Application Priority Data
Aug. 6, 2001 (FR) 01/11468

(51) Int. Cl. B29C 71/00

(52) U.S. Cl. 264/234; 264/346; 264/235

(57) ABSTRACT

According to the invention, laminated glazing is treated with a view to a subsequent operation in which the glazing will be subjected to substantial thermal stressing, especially taken to a temperature of at least 80° C., by subjecting the glazing to thermal conditioning in which it is gradually heated to a maximum temperature of 150° C. for a total time of at least 1 hour.

Application to the preparation of laminated glazing in order to undergo a treatment comprising an operation in which the glazing is taken to a temperature of at least 80° C., especially in order to undergo a process for overmolding or extruding a plastic.

The present invention relates to the field of laminated glazing. It relates more particularly to a process for treating laminated glazing with a view to a subsequent operation in which the glazing will be taken to a temperature of at least 80 or 100° C.

Among the various processes for the conversion or furnishing of glazing, some require the glazing, or at least part of it, to be taken to high temperatures of around 80 to 100° C. or higher. This is the case for example when the glazing is furnished with plastic fittings formed in situ or applied hot to the glazing.

In particular, the overmolding (or encapsulation) technique is used to produce a profiled element, in particular around the periphery of glazing, the profiled element running around at least part of the periphery of the glazing and adhering to at least one face of the glazing: the glazing, or at least part of the glazing, is placed in a mold having a cavity corresponding to the profile of the element that it is desired to produce and a molding material, which is either a molten plastic or a reactive composition, is injected into the mold.

Whether for reasons associated with the viscosity of the molten material or with the reactivity of the composition (which may require a supply of heat or else may generate heat) , the glass is generally exposed in the mold to a high temperature, of around at least 100° C., for the duration of the injection cycle, which often lasts a few minutes.

This technique, well controlled with monolithic glazing, poses a few difficulties when it is attempted to apply it to laminated glazing.

Laminated glazing consists of the combination of at least two glass sheets joined together by a thermoplastic interlayer film.

When encapsulated laminated glazing is manufactured, a substantial proportion of the products leaving the mold have defects in the laminated glass in the form of bubbles that are formed inside the laminated structure. The number of bubbles may be very high, around 50 to 200 bubbles visible to the naked eye per cm² of glazing surface.

The mechanism whereby these bubbles form is not yet fully understood, but it is certain that it is thermally activated and that the appearance of bubbles is directly associated with the temperature conditions prevailing in the mold during the overmolding operation.

It should be noted that any treatment, conversion or furnishing operation involving a thermal process at 80 or 100° C. or higher is therefore liable to generate the same kind of defect in the final product.

One means of solving this problem may lie in adapting the treatment, conversion or furnishing processes, that is to say for example adapting the encapsulation tool, but this approach appears to be difficult and above all expensive since it is liable to upset already developed industrial processes.

It would therefore be desirable to find a solution to this problem upstream of the thermal stressing operation, that is to say a solution that can be applied to the glazing itself.

This is the objective that the present invention aims to achieve.

For this purpose, the subject of the invention is a process for treating laminated glazing with a view to a subsequent operation in which the glazing will be subjected to substantial thermal stressing, especially at a temperature of at least 80° C., in particular at least 100° C., in which the glazing is subjected to thermal conditioning in which it is gradually heated to a maximum temperature of 150° C. for a total time of at least 1 hour, especially at least 4 hours.

Entirely unexpectedly, the inventors have found that prior thermal conditioning of the laminated glazing, under controlled conditions, makes it possible to inhibit the bubble formation mechanism when the laminated glazing is subsequently subjected to thermal stressing, such as that described above.

The thermal conditioning process according to the invention is based on two essential parameters, namely the rate of temperature rise and the duration of exposure to the treatment temperature.

The invention has thus demonstrated:

on the one hand, that a sudden influx of heat to laminated glazing causes the appearance of bubbles and does so even if the actual temperature of the glazing has not yet reached the known limit value for which the glazing is presumed to remain intact; and

on the other hand, that gradual heating not only does not by itself cause the appearance of bubbles, but even has a positive effect on the subsequent strength of the glazing under much harsher thermal conditions, provided that it is long enough.

Another advantageous parameter is the rest time before subsequent operations.

Although this is still merely supposition, it is possible that the thermal conditioning according to the invention causes, within the laminated glazing, a modification to the thermoplastic interlayer film that prevents the appearance of bubbles. The fact that a minimum heating time of one or more hours is required leads one to believe that this modification is governed by slow kinetics.

According to the invention, the glazing is brought gradually to a treatment temperature, that is to say the glazing is not placed directly in a chamber or brought into contact with a substance whose temperature is the treatment temperature, rather the glazing is heated at a moderate (non-infinite) rate of temperature rise, preferably less than 10° C./min.

Advantageously, the glazing is heated gradually into the temperature range of around 80 to 140° C., particularly 90 to 140° C., especially 100 or 110 to 140° C. Within this range, the resistance of the laminated assembly to bubbling improves substantially with the increase in temperature. Sufficient effectiveness is generally obtained in the case of treatment temperatures of around 90 to 110° C.

The results of the treatment are also improved by extending the duration of heating.

The heating program may consist of a gradual and continuous temperature rise at a single rate of temperature rise, or else of several steps characterized by different rates of temperature rise, each one being moderate, preferably less than 10° C./min.

According to an advantageous variant, the heating program comprises a gradual temperature rise up to a treatment temperature T₁ of less than or equal to 150° C. and at least one temperature hold, each at a treatment temperature Tᵢ (where i is a non zero integer) of less than or equal to 150° C. Each treatment temperature Tᵢ is advantageously chosen within the 80 to 140° C. range, especially in the 90 to 140° C. range or 100 to 140° C. range.

In the case of several temperature holds, these may be separated by an intermediate phase in which the temperature rises or falls, preferably at a rate of temperature rise or fall of less than 10° C./min.

In total, the duration of the heating is advantageously less than or equal to 16 hours. This is because beyond 16 hours of heating, no significant improvement in the ability of the laminated glazing to withstand thermal stressing without the appearance of bubbles is observed.

According to an advantageous embodiment, the thermal conditioning comprises, after the heating, a step in which the glazing is left to cool down to a temperature T₂ below the or the last treatment temperature and is optionally maintained at this temperature.

It has in fact been observed that a period of rest, preferably a short one, of the laminated glazing after the heating significantly improves the capability of the laminated glazing to withstand thermal stressing. The cooling down to the temperature T₂ may be rapid or gradual.

Preferably, T₂ is room temperature, that is to say around 15 to 30° C.

However, it is undesirable for the cooling down to, and the optional hold at, a lower temperature of the glazing to be too long: an increase in the bubbling phenomenon is observed in the case of glazing that has been kept too long under the critical thermal conditions before being used, since the modification associated with the thermal conditioning is at least partly reversible. This is why the duration t₂ of the cooling down to, and of the optional hold at, the temperature T₂ is preferably less than 24 hours, especially 1 to 7 hours, particularly 1 to 4 hours.

The process according to the invention applies to any type of laminated glass. This consists most conventionally of at least two sheets of float glass, each having a thickness of at least 1 mm, advantageously from 1 to 4 mm, in particular each of at least 2 mm, joined together by a translucent thermoplastic film made of a material chosen in particular from poly(vinylbutyral) (PVB), PVB-based multilayer composites such as PVB/PET with solar-protection layer (PVB) trilayers (where PET denotes polyethyleneterephthalate), or vinyl copolymers, especially those based on ethylene and a vinyl monomer, vinylidene fluoride or vinyl acetate. In general, various functional layers may be provided on at least one side of at least one sheet element of the laminated glazing.

The process for preparing glazing according to the invention will find applications for the production of laminated glazing in a variety of processes which have in common a step of thermally stressing the glazing for several minutes, comprising in particular an operation in which the glazing is taken to a temperature of at least 80 or 100° C.

Thus, the treatment process according to the invention may be intended for preparing glazing for an overmolding operation.

The thermal conditions of the process vary depending on the overmolded material, but they always involve substantial thermal stresses on the glazing.

Thus, for overmolding thermoplastics, such as poly(vinyl chloride) (PVC) or thermoplastic olefins (TPOS) or thermoplastic elastomers (TPES), a thermally activatable adhesion primer is deposited on the glazing. The glazing, heated to around 80 to 120° C. in order to activate the primer, is therefore placed in the cavity of a “cold” mold, that is to say at room temperature, and then the molten plastic is injected at a temperature of around 180° C. It is essentially contact with the injected material that causes the thermal stressing.

For overmolding crosslinkable elastomers, such as ethylene/propylene/diene rubber (EPDM), the glazing is placed “cold”, that is to say at room temperature, in the cavity of a mold heated to a temperature of about 160 to 200° C., and then the plastic is injected at a temperature of about 80 to 100° C. In this case, it is the glazing coming into contact with the hot mold, and then with the material, that causes the thermal stressing.

Finally, for overmolding a reactive composition, as in the case of the reaction injection molding (RIM) of polyurethane, the glazing is placed “cold”, that is to say at room temperature, in the cavity of a mold heated to a more moderate temperature of about 80 to 100° C., and then a composition, the temperature of which may rise under the effect of exothermic reaction up to about 120° C., is injected. In this case, it is the heating of the material in contact with the glazing that causes the thermal stressing.

The process according to the invention is also applicable in another technique, in which a profiled element is deposited by extrusion on the surface of the glazing, especially by extruding a one-component polyurethane or a thermoplastic elastomer. This process may furthermore include an operation of refacing the extruded profile by overmolding an additional or replacement component, in a localized part of the glazing.

As mentioned above, it is advantageous to carry out the thermal conditioning less than 24 hours before the subsequent conversion operation is carried out; thus, the treatment process according to the invention may be incorporated as a preliminary step of the corresponding process carried out at the converter's premises.

The following examples illustrate the invention.

Square specimens, 5 cm each side, were prepared from laminated glazing having the following structure: 2.1 mm float glass/0.76 mm PVB interlayer/2.1 mm float glass and these were subjected to the following thermal conditioning:

heating from room temperature up to a temperature T₁ in an oven at a rate of temperature rise of less than 10° C./min;

holding at the temperature T₁ for a time t₁; and

cooling to room temperature and holding at this temperature for a total time of 1.5 hours.

After the conditioning, the specimens were deposited on a plate heated to a temperature of 180° C.: the energy influx is so rapid that the rate of temperature rise may be regarded as being infinite.

The appearance of bubbles inside the laminated structure was observed and the time t_{B} after which the first bubble appeared was measured.

A control specimen that had not undergone the thermal conditioning was also subjected to this test.

The results obtained by varying T₁ and t₁ are given in Table 1 below.

TABLE 1

| | T₁ (° C.) | t₁ (h) | t_{B} (s) |
|---|---|---|---|
| control | none | None | 30 |
| according to | 100 | 4 | 150 |
| invention | | | |
| according to | 100 | 16 | 500 |
| invention | | | |
| according to | 100 | 24 | 500 |
| invention | | | |
| according to | 110 | 16 | 170 |
| invention | | | |
| according to | 110 | 24 | 270 |
| invention | | | |
| according to | 120 | 4 | 130 |
| invention | | | |
| according to | 120 | 16 | 240 |
| invention | | | |
| according to | 120 | 24 | 290 |
| invention | | | |
| according to | 130 | 4 | 130 |
| invention | | | |
| according to | 130 | 16 | 400 |
| invention | | | |
| according to | 130 | 24 | 360 |
| invention | | | |

An encapsulation trial was carried out under industrial production conditions for motor-vehicle glazing. Since the overmolding material was EPDM, the encapsulation technique consisted in depositing the laminated glazing in a hot mold, at about 180° C., in closing the mold, in injecting the material under high pressure, in holding the assembly for 90 to 180 s in the hot mold in order to cure the EPDM material, in opening the mold and then in demolding the encapsulated part. The cycle time was about 3 minutes, including 1 minute 30 seconds to 2 minutes during which a portion of the glazing (especially the periphery in contact with the mold) was taken to a temperature close to the mold temperature, that is to say 180° C. The glazing was subjected to the following thermal conditioning:

temperature rise to 100° C. at 10° C./min;

temperature hold for 16 hours; and

cooling and holding at room temperature for 1 hour 30 minutes before encapsulation.

Under these conditions, the glazing was successfully encapsulated without any bubbles appearing within the laminated structure.

Another series of encapsulation trials was carried out under the same conditions on laminated glazing with a PVB/PET multilayer interlayer film.

The results obtained by varying the temperature T₁ are given in Table 2 below.

TABLE 2

| | T₁ (° C.) | t₁ (h) | t_{B} (s) |
|---|---|---|---|
| control | none | None | 30 |
| according to | 80 | 16 | 150 |
| invention | | | |
| according to | 90 | ″ | 170* |
| invention | | | |
| according to | 100 | ″ | 230 |
| invention | | | |
| according to | 110 | ″ | 270 |
| invention | | | |
| according to | 120 | ″ | 3000 |
| invention | | | |

*if the encapsulation is carried out in a mold at a temperature of 160° C., the time for bubbles to appear is increased to 600 s.

When the rest time of the glazing treated at 110° C. before being put into the mold at 180° C. is increased, the time for bubbles to appear drops to about 80 s for a rest time of 150 h.

It is apparent from these trials that the appearance of bubbles due to heating the laminated glass can be delayed for several minutes by means of the process according to the invention.

A prolonged hold for 16 h is preferable to a hold of 4 h, but it is generally unnecessary to extend the hold to 24 h. Moreover, the results obtained are substantially improved when the treatment temperature increases.

The above description, relating more particularly to the furnishing of laminated glazing with a plastic element formed in situ, is not restricting and the invention is capable of being applied to laminated glazing subjected to many other types of thermal stressing conditions.

1. A process for treating laminated glazing with a view to a subsequent operation in which the glazing will be subjected to substantial thermal stressing, especially taken to a temperature of at least 80° C., in which the glazing is subjected to thermal conditioning in which it is gradually heated to a maximum temperature of 150° C. for a total time of at least 1 hour, especially at least 4 hours.

2. The process as claimed in claim 1, wherein the rate of temperature rise up to the treatment temperature is less than 10° C./min.

3. The process as claimed in claim 1 or 2, wherein the glazing is heated gradually into the temperature range of around 80 to 140° C.

4. The process as claimed in claim 1, wherein the heating comprises a gradual temperature rise up to a treatment temperature T₁ of less than or equal to 150° C. and at least one temperature hold, each at a treatment temperature Tᵢ (where i is a non zero integer) of less than or equal to 150° C.

5. The process as claimed in claim 1, wherein the glazing is heated for a total time of less than or equal to 16 hours.

6. The process as claimed in claim 1, wherein the thermal conditioning then includes a step, for a time t₂, in which the glazing is left to cool down to a temperature T₂ and it is optionally maintained at this temperature.

7. The process as claimed in claim 6, wherein T₂ is room temperature.

8. The process as claimed in claim 6, wherein the duration t₂ of the cooling down to, and of the optional hold at, the temperature T₂ is less than 24 hours, especially 1 to 7 hours.

9. The process as claimed in claim 6, wherein the glazing is cooled rapidly down to the temperature T₂.

10. The application of the process as claimed in claim 1 to the preparation of laminated glazing in order to undergo a treatment comprising an operation in which the glazing is taken to a temperature of at least 80° C.

11. The process as claimed in claim 1, wherein the glazing is gradually heated to a maximum temperature for at least four hours.

12. The process as claimed in claim 1, wherein the glazing is heated gradually into the temperature range of 90 to 140° C.
